(19) United States
(12) Patent Application Publication
(10) Pub. No.: US 2011/0141431 A1
(43) Pub. Date: Jun. 16, 2011

(54) DETECTING INTERACTIONS

(76) Inventor: Pamela Ann Jordan, Oxford (GB)

(21) Appl. No.: 13/057,810

(22) PCT Filed: Aug. 27, 2009
(86) PCT No.: PCT/JP2009/065372

§ 371 Date: Feb. 7, 2011

(30) Foreign Application Priority Data
Aug. 28, 2008 (GB) 0815677.0

(51) Int. Cl. G01N 21/00

(52) U.S. Cl. 349/199

(57) ABSTRACT

The present invention relates to a liquid crystal device for detecting interactions between a surface and an analyte. Specifically it provides a device for detecting interactions between a surface and an analyte, said device comprising a first substrate having an active surface supporting one or more first analyte(s), a second substrate, and a liquid crystal disposed on the active surface between the first substrate and second substrate, wherein the liquid crystal has a cross-section of varying thickness, wherein the cross-section of the liquid crystal has a first thickness and second thickness that is different to the first thickness, whereby the interaction between the active surface and the first analyte causes the orientation of the liquid crystal to change at a first critical thickness that is between the first and second thicknesses of the liquid crystal.

### TECHNICAL FIELD

The present invention relates to a liquid crystal device for detecting interactions between a surface and an analyte.

### BACKGROUND ART

Liquid crystals have properties that are normally associated with liquids and crystalline solids. For example, the molecules in liquid crystals can flow like a liquid but, at the same time, can be oriented in a crystal-like way. Typically, however, this orientational order is only partial, with the intermolecular forces striking a very delicate balance between attractive and repulsive forces. As a result, liquid crystals tend to be sensitive to external perturbations, such as the presence of foreign molecules at the liquid crystal's surface.

The orientation of a liquid crystal may be fixed by disposing the liquid crystal between two appropriate substrates, e.g. solid, liquid, gaseous or porous substrates. The mean orientation of the liquid crystal is influenced by the interfacial properties of the upper substrate as well as the lower substrate, of the liquid crystal cell. Planar alignment is where the director of the liquid crystal aligns in a direction parallel to the substrate surface whilst homeotropic alignment is where the liquid crystal director aligns in a direction perpendicular to the substrate surface. Tilted alignment refers to the case where the director is neither parallel nor perpendicular to the substrate surface. In homeoplanar or hybrid cells the alignment on one surface is planar and on the opposing surface is homeotropic.

The liquid crystal can undergo a transition between two or more anchoring directions as a result of an external perturbation, such as the adsorption of a foreign molecule on one or both substrates. In particular, the foreign molecule may modify the interface between the substrate and the liquid crystal, inducing a switch in the orientation of the liquid crystal. Typically, this switch affects the way in which light travels through the liquid crystal, providing an optical indication of the presence of the foreign molecule on the substrate.

Liquid crystals have been used to detect the presence of specific compounds. For example, U.S. Pat. No. 7,135,143 (published 7 Nov. 2002) describes a device comprising a substrate having a metallized surface. A self-assembled monolayer (SAM) comprising an alkanethiol is attached to the metallized surface and a liquid crystal is disposed on the top of the self-assembled monolayer. The alkanethiol is provided with a functional group that interacts with the specific compounds of interest. The liquid crystal interacts with the functional group, such that, when the compounds of interest are present in a sample under test, the orientation of the liquid crystal is altered. Similar devices are described in U.S. Pat. No. 6,284,197 (published 22 Feb. 2005).

In the devices of the prior art, the liquid crystals are of uniform thickness. Furthermore, the functional groups that bind with the specific compounds of interest do not alter the alignment of the liquid crystal cells. Instead, the alignment is only altered when the compounds of interest bind to the functional groups. Accordingly, it is not possible to determine whether the appropriate functional groups are coupled to the substrate before the device is put to use. Moreover, the devices can only be used to detect one type of interaction at a time; the devices cannot be easily adapted to quantify binding interactions, detect sequential interactions or to detect different interactions involving a range of compounds simultaneously in a single liquid crystal cell. Hence, a need remains for liquid crystal assays that can detect molecular interactions with a variable threshold in order to detect different strengths of interactions between a surface and at least one analyte in a single operation.

### SUMMARY OF INVENTION

The present invention makes use of a liquid crystal cell with varying spatial thickness in order to detect changes in the switching threshold due to molecular interactions at a substrate surface. The present invention can also be used to obtain quantitative information on the strength of molecular binding interactions and to confirm the correct operation of the device.

According to a first aspect of the present invention, there is provided a device for detecting interactions between a surface and an analyte, said device comprising
a first substrate having an active surface supporting a first analyte,
a second substrate, and
a liquid crystal disposed on the active surface between the first substrate and second substrate, wherein the liquid crystal has a cross-section of varying thickness.

According to a second aspect of the present invention, there is provided a method of detecting an interaction between a surface and an analyte, said method comprising
providing a first substrate having an active surface for supporting at least one analyte,
depositing a first analyte on the active surface,
providing a second substrate,
forming a liquid crystal on the active surface between the first substrate and second substrate, wherein the liquid crystal has a cross-section of varying thickness, and
detecting the orientation of the liquid crystal.

In the present invention, the liquid crystal is of varying thickness. In other words, the liquid crystal has a first part having a first thickness and a second part having a second thickness that is different from the first thickness. For example, in one embodiment, the liquid crystal has a cross-section of gradually increasing thickness (e.g. like a wedge). This may allow for increased sensitivity of the device. In another embodiment, the liquid crystal has a cross-section that increases in thickness in a stepwise manner. Such a cross-section may be easier to manufacture. In a further embodiment, the liquid crystal has a cross-section of gradually increasing then decreasing thickness (e.g. like a semi-circle).

In the present invention, the extent of the influence of the first and second substrates on liquid crystal alignment is notable since the substrates define a liquid crystal cell of varying cell thickness. For example, in homeoplanar cells, the director distribution is a function of the surface energies of the two substrates and the thickness of the liquid crystal. This in turn defines a critical liquid crystal thickness where the director distribution switches from, for example, substantially planar to substantially homeoplanar or substantially homeotropic to substantially homeoplanar.

The presence of a first analyte on one or both substrates also affects the alignment of the liquid crystal. In particular, the analyte may modify the interface between the substrate and the liquid crystal, inducing a switch in the orientation of the liquid crystal.

The liquid crystal cell employed in the present invention, by means of spatially varying thickness, reports changes in anchoring energies, due to interactions between the surface and at least one analyte over a wide range of initial values.

As discussed above, the varying thickness of the liquid crystal allows an analyte to switch the orientation of the liquid crystal (e.g. from homeotropic to homeoplanar or vice-versa) at a specific or critical liquid crystal thickness. This critical thickness is preferably between the first thickness and second thickness of the liquid crystal. Advantageously, this changes the way in which light travels through the liquid crystal at the critical thickness, and can be designed to provide the user with an indication that the analyte has been deposited correctly. The position at which this change may be first detected is known as the switching position of the liquid crystal.

The varying thickness of the liquid crystal may also allow a user to detect different analytes using the same device, as different analytes can switch the orientation of the liquid crystal at different critical thicknesses. Furthermore, the presence of a further (e.g. second) analyte bound to the first analyte may cause the orientation of the liquid crystal to be switched at a different critical thickness, allowing sequential interactions to be detected. This different critical thickness is between the first and second thickness of the liquid crystal.

In one embodiment, the first analyte may be any compound that acts as a receptor for the second analyte. The first analyte may be an organic or an inorganic moiety. Examples include metal ions, and drug or biological molecules, such as proteins, antibodies, peptides, metabolites, nucleic acids, antigens, allergens, polymers or combinations thereof. The first analyte may be selected as a receptor for detecting the presence of other molecules, such as physiological and/or pharmacological metabolites, in, for example, a biological fluid sample (e.g. human or animal). This may reveal important diagnostic or prognostic information on the patient. The first analyte (e.g. drug or biological molecule) may be derived from natural sources or may be produced by synthetic methods. In one embodiment, a library of synthetic peptides are employed to detect the presence of a range of different second analytes.

The second (or further) analyte may be any compound that requires detection. For example, the second (or further) analyte may be a poison or pollutant, such as a herbicide, pesticide, waste product or agent of war. The second (or further) analyte may also be any organic or inorganic moiety, such as metal ions and drug or biological molecule. Such compounds may be present in any biological sample (e.g. biological fluid) under test and may include proteins, metabolites, antibodies, peptides, nucleic acids, antigens, allergens, polymers or combinations thereof. As with the first analyte, the second (or further) analyte may be derived from natural sources or may be produced by synthetic methods.

In an alternative embodiment, it may be the first analyte that is the compound that requires detection and the second analyte that acts as a receptor to the first analyte. In this instance, the compounds requiring detection are attached to the substrate surface subsequently enabling suitable receptors to be identified, e.g. small molecule arrays.

As mentioned above, the liquid crystal has a first part having a first thickness and a second part having a second thickness that is different from the first thickness. Preferably, this difference in thickness is such that the interaction between the surface and the first analyte causes the orientation of the liquid crystal to switch at a first critical thickness that is between the first thickness and second thickness of the liquid crystal. The difference between the first thickness and the second thickness may vary from 0.1 nm to 5 mm, preferably 100 nm to 500 microns, more preferably 1 micron to 200 microns. A difference of less than 0.1 nm may be hard to manufacture, whereas a difference of more than 5 mm may result in an unwieldy device. The second thickness may be 2 to 108 times greater, preferably 10 to 104 times greater, more preferably 50 to 1000 times greater than the first thickness. In one embodiment, the first thickness and second thickness are minimum and maximum thicknesses of the liquid crystal, respectively.

In one embodiment, once the first analyte is deposited on the active surface, the substrate may be contacted with a sample containing a further analyte before the liquid crystal is formed on the substrate. If the further analyte binds to the first analyte, the interface between the substrate and the liquid crystal is altered and, as a result, the orientation of the liquid crystal switches at a critical thickness that is specific to the further analyte. Preferably, this critical thickness is different to the critical thickness of the first analyte, allowing the binding of the second analyte to be detected.

In another embodiment, once the first analyte is deposited on the active surface and the liquid crystal is formed on the substrate, the further analyte is contacted with the liquid crystal and allowed to diffuse through to the first analyte. If the further analyte binds to the first analyte, the interface between the substrate and the liquid crystal is altered and, as a result, the orientation of the liquid crystal switches at a critical thickness that is specific to the further analyte. Preferably, this critical thickness is different to the critical thickness of the first analyte, allowing the binding of the second analyte to be detected.

Monitoring the change in the switching positions between the first analyte attached to a surface and a second analyte attached to the first analyte can reveal quantitative information on the interactions. Firstly, the initial switching position can give information on the density of the first analyte attached to the active surface. The second switching position can reveal whether or not the first analyte underwent an interaction with the second analyte. The relative shift from the first to second switching positions can reveal information on the number of interactions that occurred. Hence, ratiometric (self-calibrating) binding information can be gained through monitoring the change in switching position. This provides a further advantage in that it is not necessary to know the optimal switching conditions for each different interaction.

Once the second analyte is bound to the first analyte, the substrate may be contacted with a sample containing yet another analyte before the liquid crystal is formed on the substrate. This further interaction may cause the liquid crystal to switch at yet another critical thickness, allowing the further interaction to be detected. In this way, the device may be used to detect a series of interactions and is not limited solely to the interaction between the first and second analyte.

The first analyte may be deposited on the active surface of the first substrate in any suitable manner. Preferably, however, the first analyte is deposited on the active surface in discrete regions. In one embodiment, the first analyte is deposited on the active surface in an array. For example, an array of different first analytes may be employed. Alternatively, the first analyte may be deposited in a continuous manner, i.e. the active surface is covered with a uniform layer of first analyte.

The first analyte may be attached to the active surface of the first substrate by any suitable interaction. For example, the first analyte may be attached to the active surface of the first substrate by covalent bonding, ionic bonding, hydrogen-bonding, electrostatic attraction/repulsion, hydrophobic/hydrophilic interactions, Van der Waal's interactions, chemisorption, physisorption or a combination thereof. In one embodiment, the interaction occurs via the hydrophobic effect. In a preferred embodiment, the first analyte is attached to the surface of the first substrate by a hydrophobic or covalent interaction or via the formation of disulphide bonds.

Where a second (or further) analyte is bound to the first analyte, the interaction between the analytes may occur by covalent bonding, ionic bonding, hydrogen-bonding, electrostatic attraction/repulsion, hydrophobic/hydrophilic interactions, Van der Waal's interactions, chemisorption, physisorption or a combination thereof. In one embodiment, the interaction occurs via the formation of disulphide bonds. In a preferred embodiment, the second analyte is attached to the first analyte by a non-covalent interaction. For example, the first analyte may be attached to the active surface by a hydrophobic or covalent interaction and the second analyte may be attached to the first analyte by a non-covalent interaction.

The device of the present invention may be used to detect one or more second analytes. For example, where an array of different first analytes are deposited on the active surface, the device may be used to detect an array of different second analytes.

The density at which the first analyte is deposited on the active surface of the first substrate may be tailored, such that the liquid crystal orientation switches at a predetermined or preferred thickness of liquid crystal.

In some embodiments, the orientation of the liquid crystal may be determined at different liquid crystal thicknesses in order to determine the critical thickness at which the interaction between the first analyte and the active surface causes a change in liquid crystal orientation. This may also be carried out where there is a further (i.e. second) analyte. The orientation of the liquid crystal may be determined by standard means.

The device of the present invention may be used in a variety of applications. For example, the device may be used to detect the presence of pollutants or poisons in a liquid or gaseous sample. Examples of such samples include samples from, for example, lakes, rivers, ponds and the sea, as well as waste streams from industrial or agricultural processes.

Alternatively, the device may be used to detect the presence of certain compounds in biological fluids, such as bodily fluids from, for example, humans or animals. This can be used to provide diagnostic or prognostic information. Examples of bodily fluids to be tested include blood, urine, tears, sweat, saliva and semen.

The device may also be used in pharmaceutical research and development, particularly for helping to identify suitable compounds in drug screening assays such as drug docking, drug discovery and drug function prediction. A further advantage is that this technique need not rely on fluorescent labelling for transduction which may also inadvertently affect the binding properties of the drugs being screened and/or tested. Furthermore, the current invention does not require the use of radioactive labels negating the hazards associated with handling and disposing of radioactive material.

The device may further be used for monitoring air quality, e.g. for detecting allergens such as pollens, moulds and dust mites.

The first analyte deposited on the active surface of the device may act as a receptor for the compounds to be detected. The compounds to be detected bind to the receptors and, therefore, act as second or subsequent analytes. Alternatively, the first analyte deposited on the active surface may be the compound to be detected and the subsequent analytes are receptors that may bind to the compound of interest. This technique may be particularly applicable in pharmaceutical research and development where new drugs (receptors) for different compounds have to be identified.

Any suitable substrate may be used as the first and/or second substrate of the device. The substrate defines the liquid crystal cell and, advantageously, influences the alignment of the liquid crystal. The first substrate may or may not be made from the same material as the second substrate. The first and/or second substrate may be optically transparent, optically semi-transparent or optically opaque. The substrate(s) may be solid, liquid, gaseous or gelatinous, provided they enable a liquid crystal with appropriate cross-section and orientation to be employed. The substrate(s) may be porous or non-porous. Preferably, the second substrate is solid like the first substrate.

Suitable materials for forming the substrates employed in the present invention include inorganic crystals, inorganic oxides, metals, organic polymers and combinations thereof.

Suitable inorganic crystals include LiF, NaF, NaCl, KBr, KI, CAF₂, MgF₂. HGF₂, BN, AsS₃, ZnS and Si₃N₄.

Suitable metals include gold, silver, platinum, palladium, nickel, aluminium and copper. Metal alloys and metal composites may also be employed.

Suitable inorganic oxides include Cs₂O, Mg(OH)₂, TiO₂, ZrO₂, CeO₂, Y₂O₃, Cr₂O₃, Fe₂O₃, NiO, ZnO, Al₂O₃, SiO₂ (glass), quartz, In₂O₃, SnO₂, and/or PbO₂. Preferably, the first and/or the second substrate is formed from a glass or quartz substrate.

Suitable organic polymers include polyalkanes (e.g. polyethylene, polypropylene), polyacrylics, polyvinyls, polystyrenes, polycarbonates, polyesters, polyurethanes, polyamides, polycarbonates, polyesters, polyurethanes, polyamides, polyimides, polysulfone, polysiloxanes, polyheterocycles, cellulose derivatives, polysilanes, fluorinated polymers, epoxides, polyethers and phenolic resins. Preferred organic polymers include polypropylene, polystyrene, polydimethylsiloxane, polymethylmethacrylate and polyvinylidene fluoride. The organic polymers may be porous or non-porous.

Suitable substrates are described in U.S. Pat. No. 6,284,197 (published 22 Feb. 2005).

The surface of the substrate(s) may have an effect on the anchoring of the liquid crystal layer. The surface may be engineered to influence the orientation of the liquid crystal in a particular manner prior to the introduction of the analyte(s). For example, the surface(s) of the substrate(s) may be engineered to preferentially orient the liquid crystal in a planar manner or a homeotropic manner. Various techniques may be used to control the alignment properties of the surface(s). These include mechanical and/or chemical techniques. In one embodiment, the surface of the substrate may provide anchoring for the liquid crystal through rubbing, etching, grooving or stretching. Techniques, such as photolithography, chemical etching and micro-contact printing can also be used.

Alternatively or additionally, the surface of the substrate may be functionalised, for example, with reactive groups, such as amine, hydroxyl, carboxylic, alkene, sulfhydryl and siloxane groups. Metal coatings, organic coatings and/or self-assembled monolayers may also be applied to the substrate to preferentially orient the liquid crystal in the desired manner. Where metal coatings are used, these may be deposited on the substrate(s) by techniques, such as electrochemical deposition, sputtering and evaporative deposition. These coatings are preferably optically transparent or semi-transparent. Suitable surface treatments and coatings are described in U.S. Pat. No. 6,284,197 (published 22 Feb. 2005).

In a preferred embodiment, the substrate(s) used are glass substrates coated with indium tin oxide.

Any suitable liquid crystal may be used to form the device of the present invention. The liquid crystal may be a thermotropic liquid crystal or a lyotropic liquid crystal. Where a thermotropic crystal is used, the crystal may be nematic, smectic, chiral or discotic. Where a lyotropic crystal is used, the crystal may be hexagonal, cubic or lamellar.

The term “mesogen”, when used in reference to liquid crystals, will be understood by those of skill in the art. Briefly, the mesogen is the fundamental unit of a liquid crystal that induces structural order in the crystals.

Suitable thermotropic liquid crystals have the general formula I below.

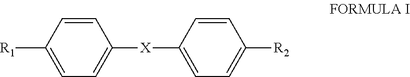

X may be selected from a single bond or a group selected from —C═N—, —N═N—, —N═NO—, —CH═NO—, —CH═CH—, —C≡C—, and —OCO— groups.

R₁ and R₂ are independently selected R groups. Presently preferred R groups include, but are not limited to, alkyl groups, lower (e.g. C₁ to C₆) alkyl, substituted alkyl groups, aryl groups, acyl groups, halogens, hydroxy, cyano, amino, alkoxy, alkylamino, acylamino, thioamido, acyloxy, aryloxy, aryloxyalkyl, mercapto, thia, aza, oxo, both saturated and unsaturated cyclic hydrocarbons, heterocycles, arylalkyl, substituted aryl, alkylhalo, acylamino, mercapto, substituted arylalkyl, heteroaryl, heteroarylalkyl, substituted heteroaryl, substituted heteroarylalkyl, substituted heterocyclic, heterocyclicalkyl.

In a presently preferred embodiment X is a bond linking the two phenyl groups and the mesogen is a biphenyl. In another preferred embodiment X is a —C═N— bond and the mesogen is a Schiff base. In still further preferred embodiments R₁ and R₂ are independently selected from the group consisting of alky, alkoxy and cyano moieties.

In a particularly preferred embodiment, the mesogen is a member selected from the group consisting of 4-cyano-4′pentylbiphenyl (5CB), N-(4-methoxybenzylidene)-4-butlyaniline and combinations thereof. The liquid crystal is preferably 5CB or may be a liquid crystal containing 5CB, such as E7.

Lyotropics liquid crystals are based on surfactant materials dissolved in a solvent such as water. Surfactant materials have a polar head and a non-polar tail. Lyotropic liquid crystals include, but are not limited to, cetylpiridinium chloride, sodium decyl sulphate, sodium oleate, sodium laurate and lecithin.

Lyotropic chromonic liquid crystals tend to be aromatic rather than aliphatic. They tend not to have significant surfactant properties like standard lyotropic liquid crystals. Examples of lyotropic chromonic liquid crystals include, but are not limited to, cromolyn sodium, and dyes such as Direct Blue 67 and Red 14.

The type of liquid crystal employed in the present invention may be selected specifically to enhance the detection of particular interactions, such as the interaction between the first analyte and the active surface and/or the first analyte and the second analyte.

The particular anchoring direction adopted by the liquid crystal will depend on a number of factors, including the nature of the surface of the substrate and the liquid crystal mesogens. For example, the liquid crystals may be homeotropic in the sense that they are aligned in a direction perpendicular to the surface of the substrate. Alternatively, the liquid crystal mesogens may be planar in the sense that they are aligned in a direction parallel to the substrate's surface. The liquid crystal mesogens may also be tilted where the director of the liquid crystal mesogen forms an angle with the normal to the surface that is between 0 and 90 degrees. In one embodiment, the anchoring of the liquid crystal is homeoplanar. Accordingly, the liquid crystal mesogens at one surface are homeotropic, while the liquid crystal mesogens at the other surface are planar. In this embodiment, the director of the liquid crystals in the bulk phase rotates up to 90 degrees and is generally of a tilted geometry.

As mentioned above, the presence of an analyte can switch the orientation of the liquid crystal mesogens at a critical liquid crystal thickness. This can change the way in which light travels through the liquid crystal. This change may be detected using any suitable method. For example, the change may be detected optically. This optical observation may be carried out under ambient light. Alternatively, the device may be backlit with a source of light. The light through the device may be viewed through crossed polarisers. Alternatively or additionally, the substrate(s) may act as crossed polarisers. For example, the substrate(s) may be formed from polarised glass. The device may be observed directly by an operator and/or it may be photographed using any suitable photographic equipment. If desired the first, second or subsequent analyte may be provided with a tag, such as a fluorescent marker. This allows the analyte to be more easily detected, for example by use of equipment able to detect the tag. For a fluorescent marker, this may be, for example, a Typhoon Trio Plus variable mode imager (Amersham Biosciences).

According to yet another aspect of the present invention, there is provided an apparatus for detecting an interaction between a surface and an analyte, said apparatus comprising
means for receiving a first substrate having an active surface for supporting at least one analyte,
a second substrate, and
means for forming a liquid crystal of varying thickness between a first substrate positioned in the apparatus and the second substrate.

To use the apparatus, a first substrate may be inserted into the apparatus, such that first substrate and second substrate define a cavity for the liquid crystal. When a liquid crystal is introduced into this cavity, a liquid crystal of varying thickness is formed. The liquid crystal may be introduced by any suitable means. Preferably, the cavity is sized such that it may be filled by capillary forces.

According to yet a further aspect of the present invention, there is provided an apparatus for detecting an interaction between a surface and an analyte, said apparatus comprising
means for receiving a first substrate having an active surface for supporting at least one analyte and a liquid crystal layer of varying thickness,
means of contacting the liquid crystal with the sample to be analysed.
a second substrate, and
means of contacting the second substrate with the liquid crystal once it has been contacted with the sample.

To use the apparatus, the first substrate may be inserted into the apparatus such that the substrate comes into contact with the sample to be analysed. The sample may be introduced by any suitable means. Preferably the sample is introduced to the liquid crystal layer through direct contact. The second substrate may then be contacted with the liquid crystal. Preferably, the second substrate would be a liquid containing the sample although any suitable substrate could be used.

In both apparatuses, the orientation of the liquid crystal may be detected as described above to detect any interactions between the active surface of the first substrate and any analytes on the active surface.

Both apparatuses may be a handheld apparatus.

The phrase “means for receiving” is intended to encompass any suitable means for introducing the substrate into the apparatus. Such means will be readily apparent to those of skill in the art.

The foregoing and other objectives, features, and advantages of the invention will be more readily understood upon consideration of the following detailed description of the invention, taken in conjunction with the accompanying drawings.

### BRIEF DESCRIPTION OF DRAWINGS

These and other aspects of the invention will now be described with reference to the accompanying drawings, in which:

FIGS. 1a to 1c depict schematic views of a device according to a first embodiment of the present invention;

FIGS. 2a and 2b depict schematic views of a device according to a second embodiment of the present invention;

FIGS. 3a and 3b depict schematic views of a device according to a third embodiment of the present invention;

FIGS. 4a and 4b depict schematic views of a device according to a fourth embodiment of the present invention;

FIGS. 5a and 5b depict schematic views of a device according to a fifth embodiment of the present invention;

FIGS. 6a to 6c depict schematic views of a device according to a sixth embodiment of the present invention;

FIGS. 7a to 7c depict schematic views of a device according to a seventh embodiment of the present invention;

FIGS. 8a and 8b depict schematic views of a device according to a eighth embodiment of the present invention;

FIGS. 9a and 9b depict schematic views of a device according to a ninth embodiment of the present invention;

FIGS. 10a to 10c depict schematic views of substrates that may be used in a device according to the present invention;

FIGS. 11a to 11c depict schematic views of substrates that may be used in a device according to the present invention; and

FIGS. 12a-b, 13a-c, 14a-c and 15a-b show the results of the experiments conducted in Examples 1, 2, 3 and 4, respectively.

### DESCRIPTION OF EMBODIMENTS

### Embodiment 1

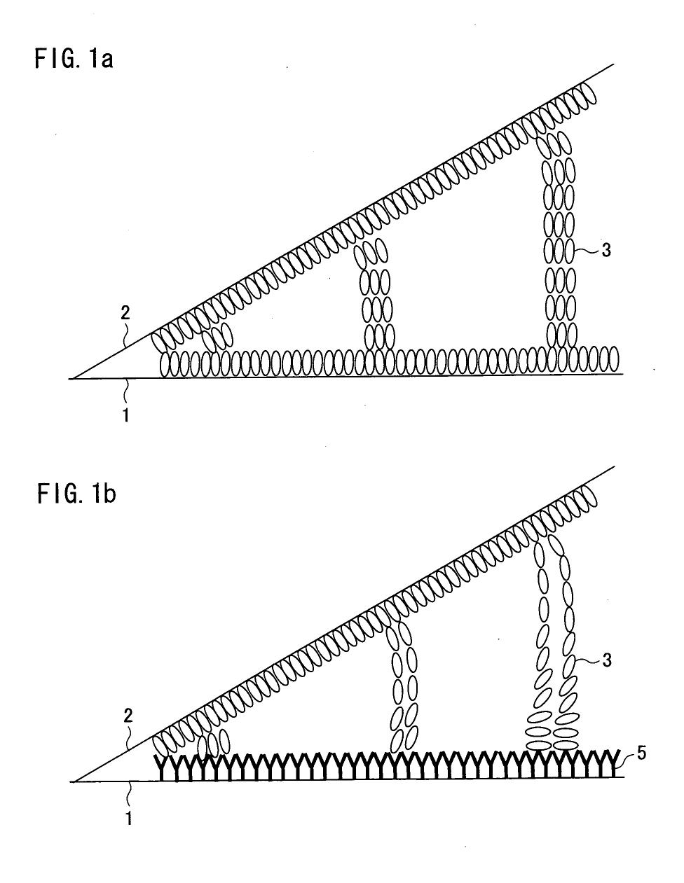

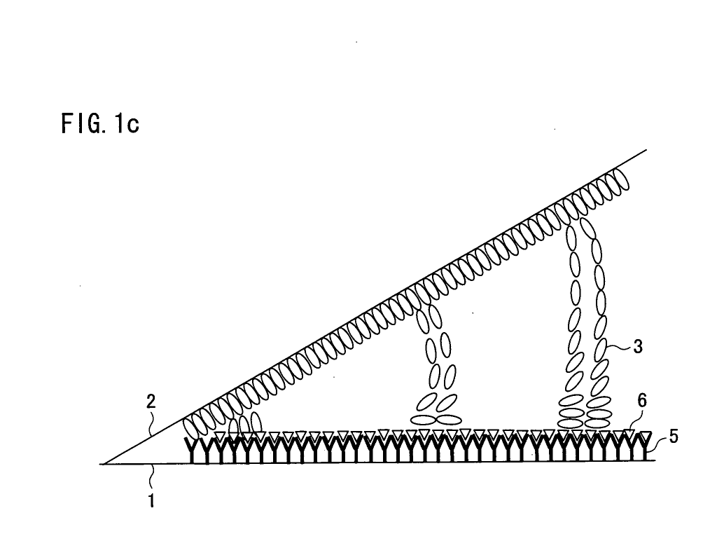

Referring to FIGS. 1a to 1c, these Figures depict a device comprising a first substrate (active surface) (1) and a second substrate (2). A liquid crystal (3) of continually changing thickness is disposed between the substrates. As shown in FIG. 1a, the first and second substrates provide strong homeotropic anchoring for the liquid crystal.

Continuous regions of a first analyte (5) are deposited onto the first substrate as shown in FIG. 1b. The first analytes provide a weak planar anchoring for the liquid crystal and cause the orientation of the liquid crystal to switch from homeotropic to tilted at the first surface at a first critical thickness.

A second analyte (6) is attached to the first analyte as shown in FIG. 1c. This provides a planar anchoring for the liquid crystal that is stronger than that provided by the first analyte alone. This causes the liquid crystal to switch orientation from homeotropic to tilted at a critical thickness that is less than that required for the first analyte alone.

### Embodiment 2

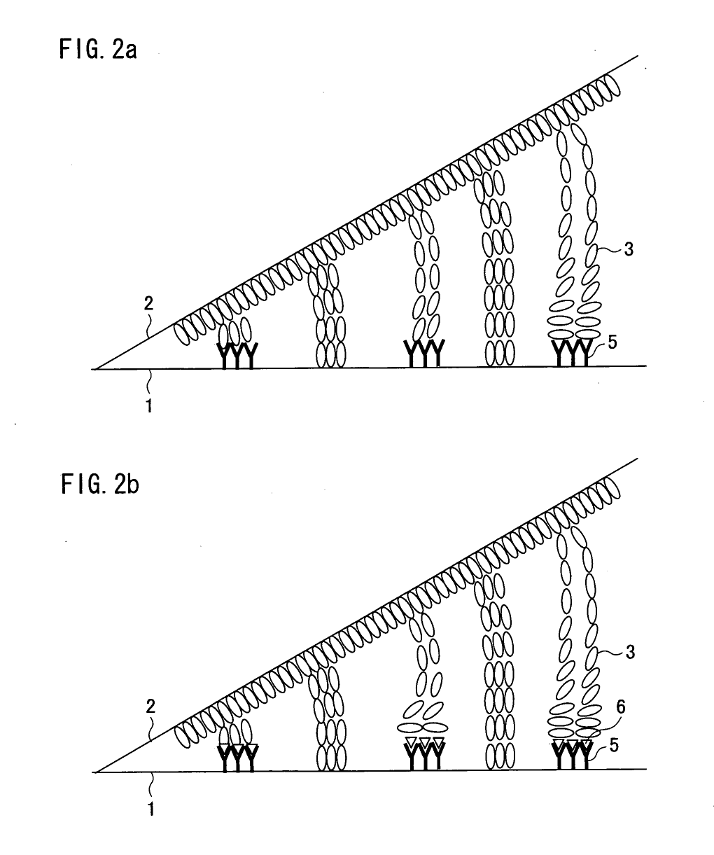

In this embodiment, discrete regions of a first analyte (5) are bound to the first substrate (active surface) (1) (see FIG. 2a). The first analyte provides a weak planar anchoring for the liquid crystal and causes the orientation of the liquid crystal to switch from homeotropic to tilted at the first surface at a first critical thickness.

A second analyte (6) is attached to the first analyte as shown in FIG. 2b. This provides a planar anchoring for the liquid crystal that is stronger than that provided by the first analyte alone. This causes the liquid crystal to switch orientation from homeotropic to tilted at a liquid crystal thickness that is less than that required for the first analyte alone. The regions which have not interacted with a first analyte remain homeotropically aligned at the first surface.

### Embodiment 3

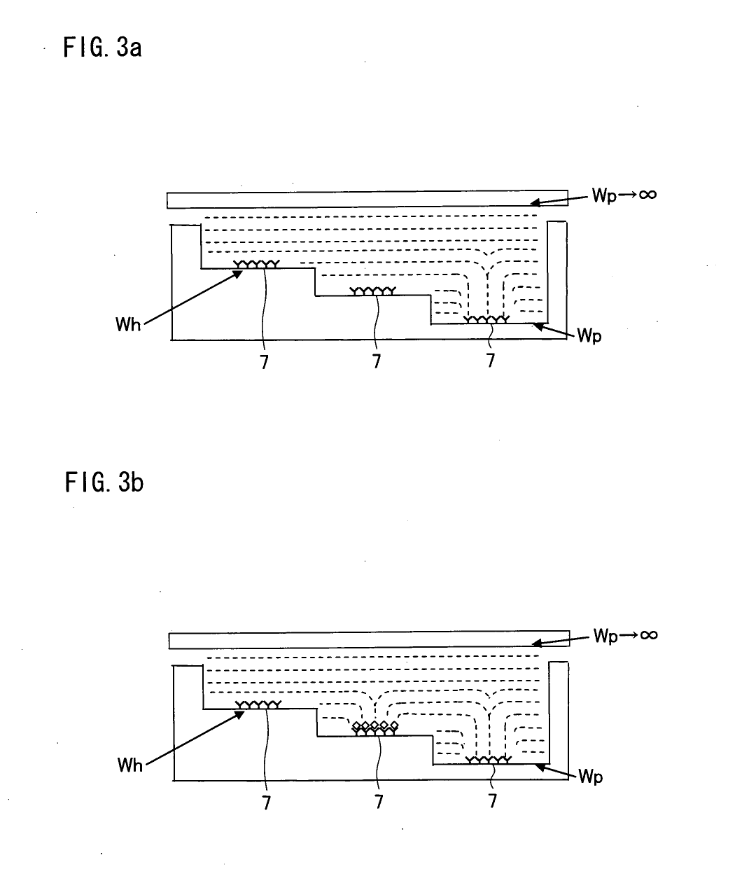

This embodiment uses planar anchoring surfaces, with a spatially varying thickness of liquid crystal, with homeotropic (Wₕ) first analytes attached to the surface (7) as shown in FIG. 3a. The top surface provides strong planar anchoring, Wₚ→∞. This causes the liquid crystal to switch from a planar to a tilted orientation at a first cell thickness. The first analyte is then interacted with a second analyte that is also capable of inducing homeotropic liquid crystal orientation. The bound first and second analytes generate a stronger homeotropic anchoring surface than the first analyte alone. This causes the liquid crystal to switch orientation from planar to homeotropic at a cell thickness that is thinner than that for the first analyte alone. This is shown in FIG. 3b.

### Embodiment 4

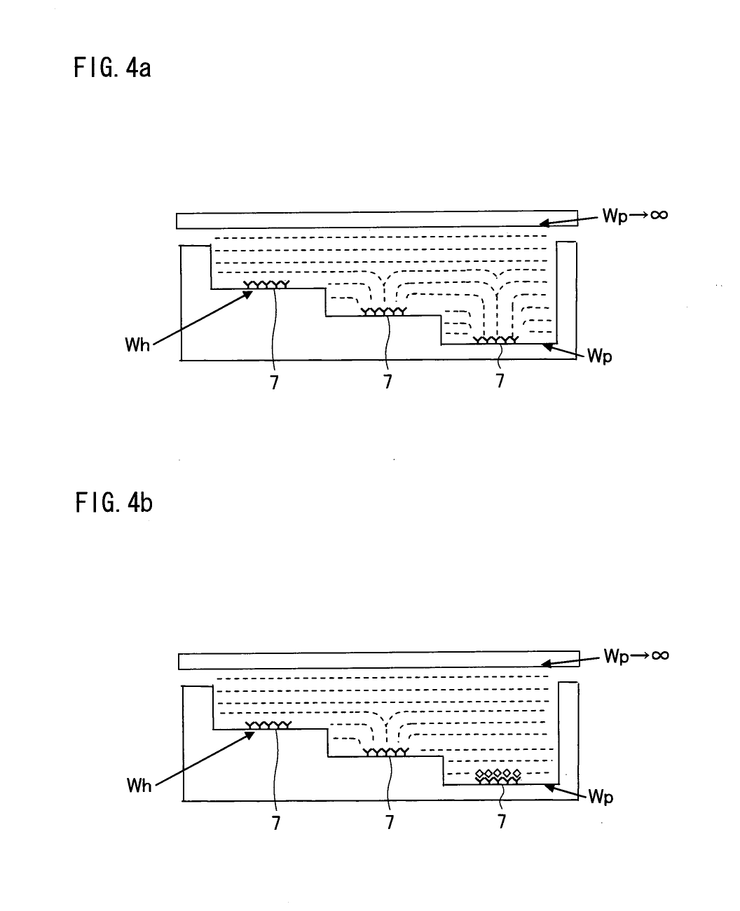

This embodiment uses planar anchoring surfaces, which provide a spatially varying thickness of liquid crystal, with homeotropic (Wₕ) anchoring first analytes attached to the surface (7). In this instance the second analytes are capable of inducing planar anchoring of the liquid crystal. The upper surface has strong planar anchoring, Wₚ→∞. Therefore homeotropic anchoring first analytes attached to the lower surface will cause the liquid crystal to switch to a homeoplanar alignment at a first cell thickness (see FIG. 4a). Interacting a planar anchoring second analyte with the first analyte on the surface will cause the liquid crystal to switch back towards planar alignment (FIG. 4b).

### Embodiment 5

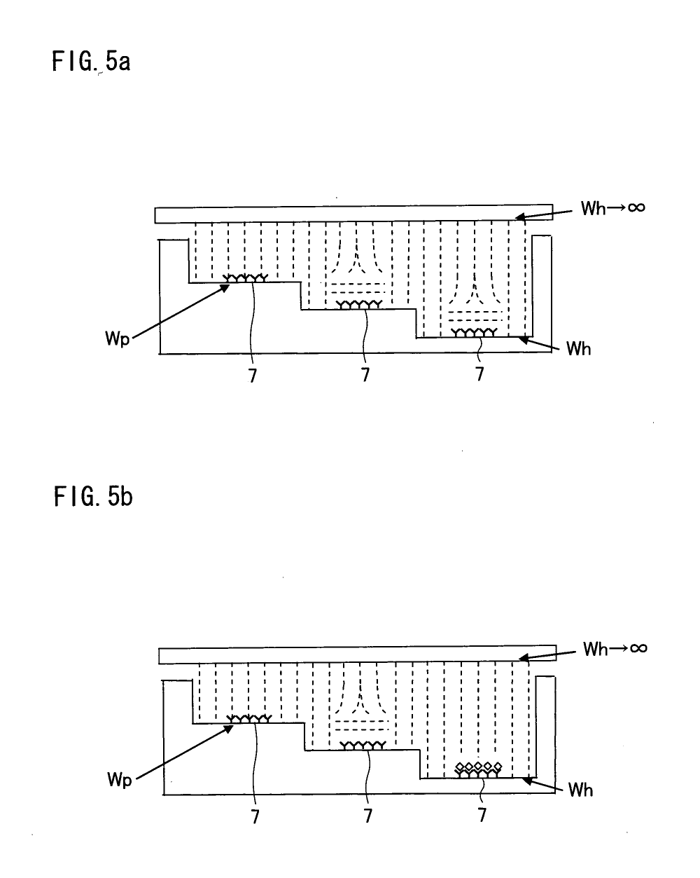

This embodiment uses homeotropic anchoring surfaces, which provide a spatially varying thickness of liquid crystal, with planar anchoring (Wₚ) first analytes attached to the surface (7). In this instance the second analytes are capable of inducing homeotropic anchoring of the liquid crystal. The upper surface has strong homeotropic anchoring Wₕ→∞. Therefore planar anchoring first analytes attached to the lower surface will cause the liquid crystal to switch to a homeoplanar alignment at a first cell thickness (see FIG. 5a). Interacting a homeotropic anchoring second analytes with the first analytes on the surface will cause the liquid crystal to switch back towards homeotropic alignment (see FIG. 5b).

### Embodiment 6

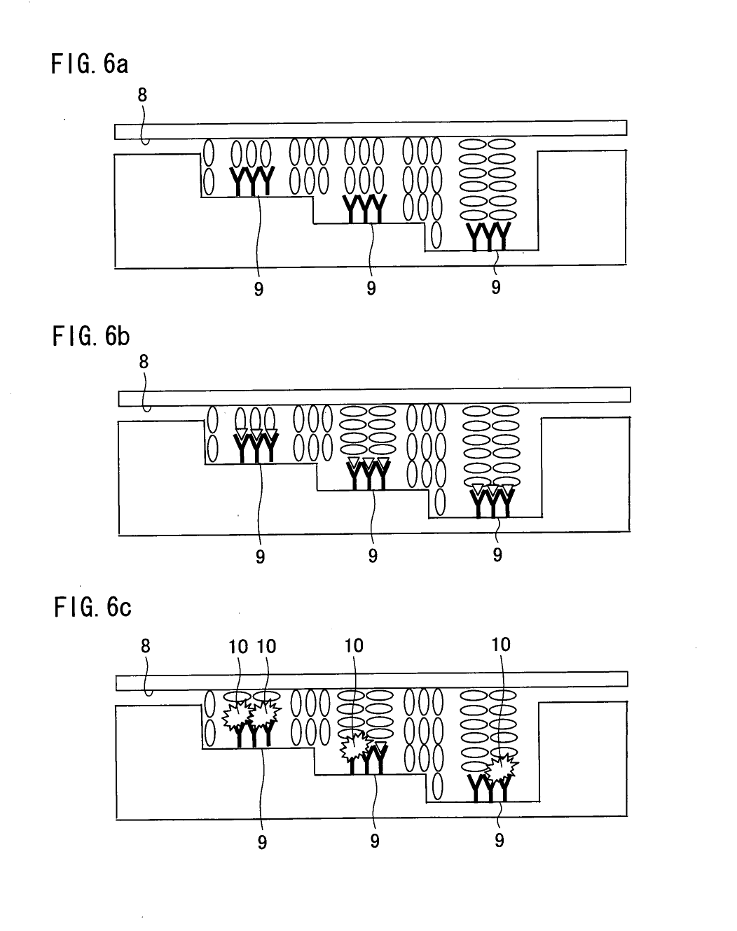

This embodiment describes how a contaminated sample may be identified. In this example, the upper surface (8) has strong homeotropic anchoring, Wₕ→∞, with planar anchoring first molecular moieties attached to a homeotropic anchoring lower surface (9). FIG. 6a shows how the liquid crystal would align under these initial conditions, with the planar analytes attached to the lower surface causing the liquid crystal to switch from homeotropic to planar orientation at a first critical thickness. By interacting the first analytes with a second planar anchoring analyte, the critical thickness at which the liquid crystal changes from homeotropic to homeoplanar orientation changes, as shown in FIG. 6b. FIG. 6c shows what would happen in the event that the sample was contaminated. The liquid crystal would switch position at a critical cell thickness less than that for either the first analyte on the surface or a second analyte attached to the first analyte on the surface. Large contaminants (10) in particular will disrupt the alignment of the liquid crystal in thin cells via mechanical distortion. Switching at the third position would indicate contamination of the cell.

### Embodiment 7

This embodiment extends to probing interactions between analytes that are capable of binding to more than one other molecular moiety simultaneously. Multiple binding interactions at a single binding site can be investigated.

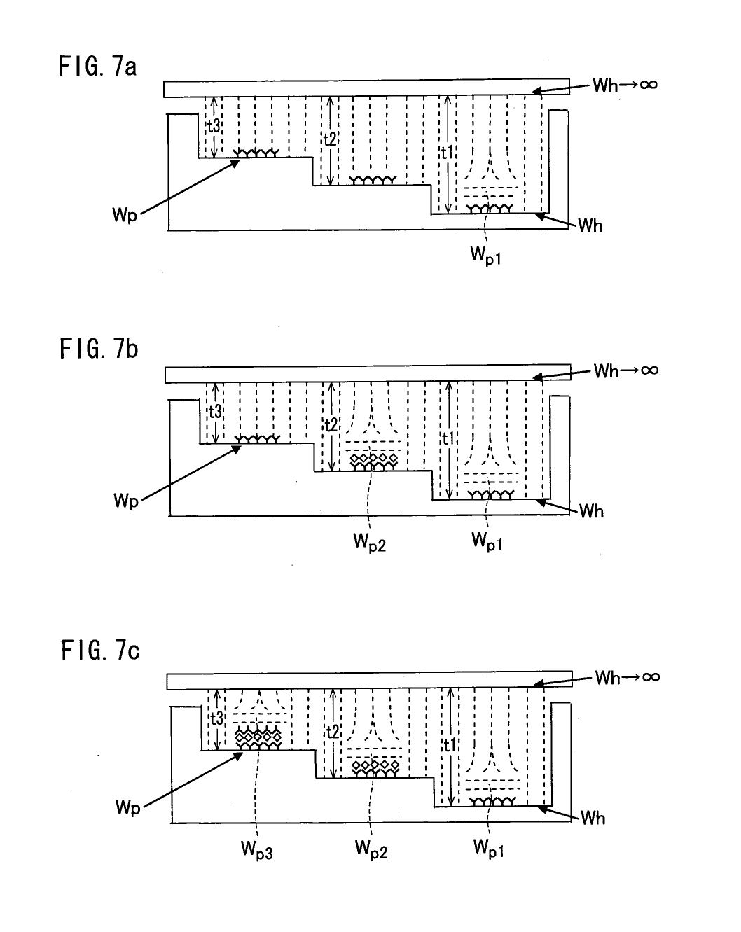

Consider a system where the first and second substrates provide a continually changing thickness of liquid crystal layer. The first and second substrates provide strong homeotropic anchoring, Wₕ→∞, for the liquid crystal. Continuous regions of a first analyte are deposited onto the first substrate. The first analytes provide a weak planar anchoring, Wₚ₁, for the liquid crystal and therefore cause the orientation of the liquid crystal to switch from homeotropic to tilted at the first surface at a first cell thickness (t1). (See FIG. 7a). A second analyte is attached to the first analyte, Wₚ₂. This provides a planar anchoring for the liquid crystal that is stronger than that provided by the first analyte alone, Wₚ₂>Wₚ₁. (See FIG. 7b). This causes the liquid crystal to switch orientation from homeotropic to tilted at a cell thickness (t2) that is less than that required for the first analyte alone (t2<t1). A third analyte is attached to the first and second analytes, Wₚ₃. This provides a planar anchoring for the liquid crystal that is stronger than that provided by the first and second analytes (Wₚ₃>Wₚ₂). This causes the liquid crystal to switch orientation from homeotropic to tilted at a cell thickness (t3) that is less than that required for the first analyte alone and the bound first and second analytes (t3<t2<t1) as illustrated in FIG. 7c.

### Embodiment 8

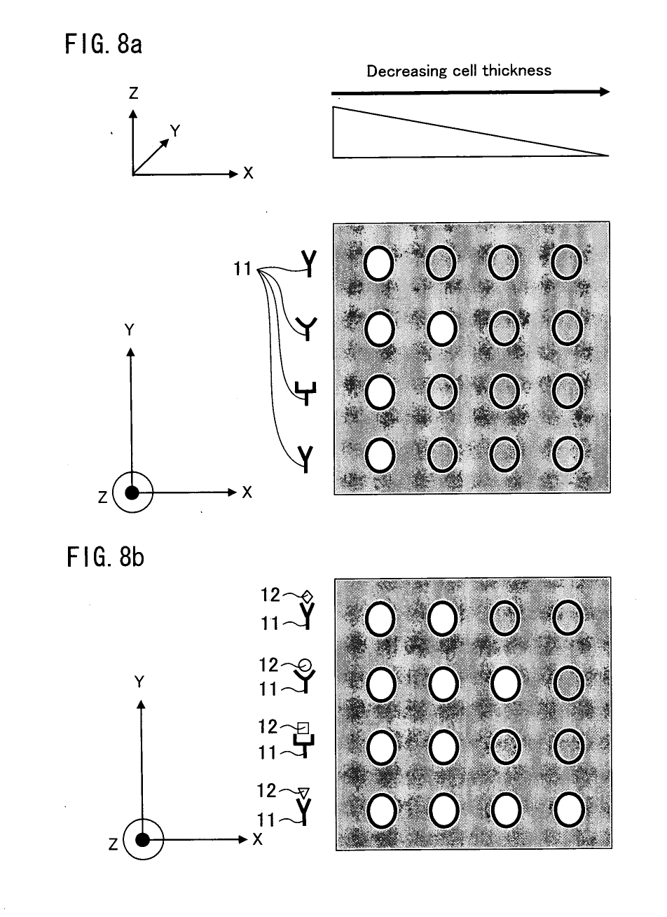

In this embodiment, the device comprises an array of different first (11) and different second (12) analytes. FIG. 8 shows a liquid crystal cell which is decreasing in thickness and contains discrete spots of three different first analytes attached to a lower surface, (See FIG. 8a). The surfaces induce homeotropic orientation of the liquid crystal and the three different first analytes induce planar alignment of the liquid crystal. The strength of the planar alignment of each of the different first analytes may all be different. Therefore, each initial switching boundary may be different. The binding of four different second planar anchoring analytes (each of which may have different planar anchoring strengths) to the first analyte results in varying shifts in the lateral position at which the liquid crystal changes orientation (See FIG. 8b).

### Embodiment 9

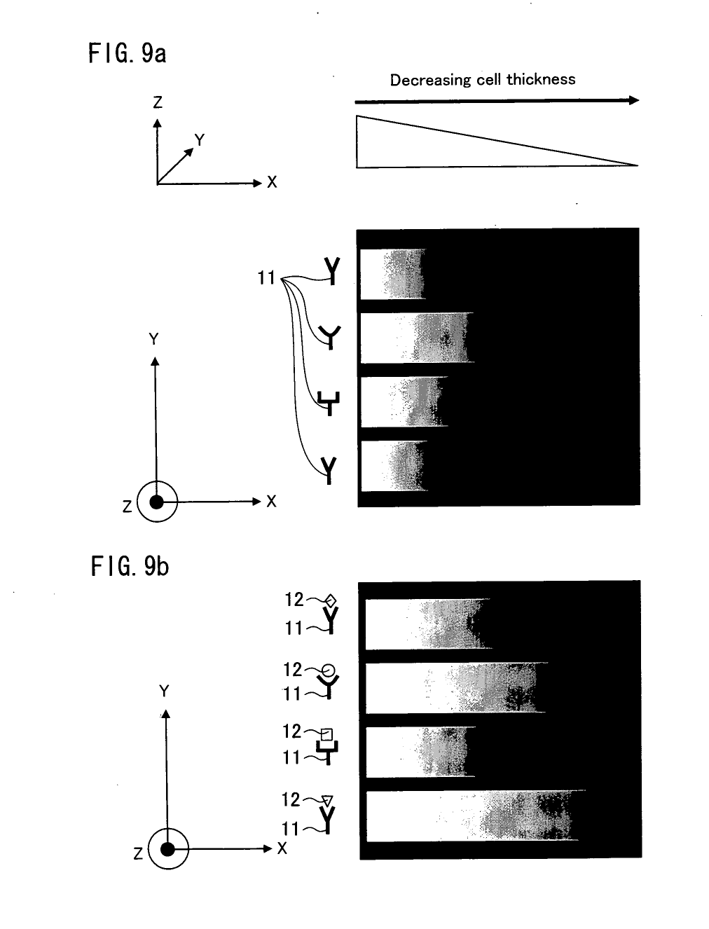

This embodiment represents the same series of interactions as described in embodiment 8, but in this instance the first analytes (11) attached to the surface are deposited in continuous regions as opposed to discrete areas. (See FIG. 9).

### Embodiment 10

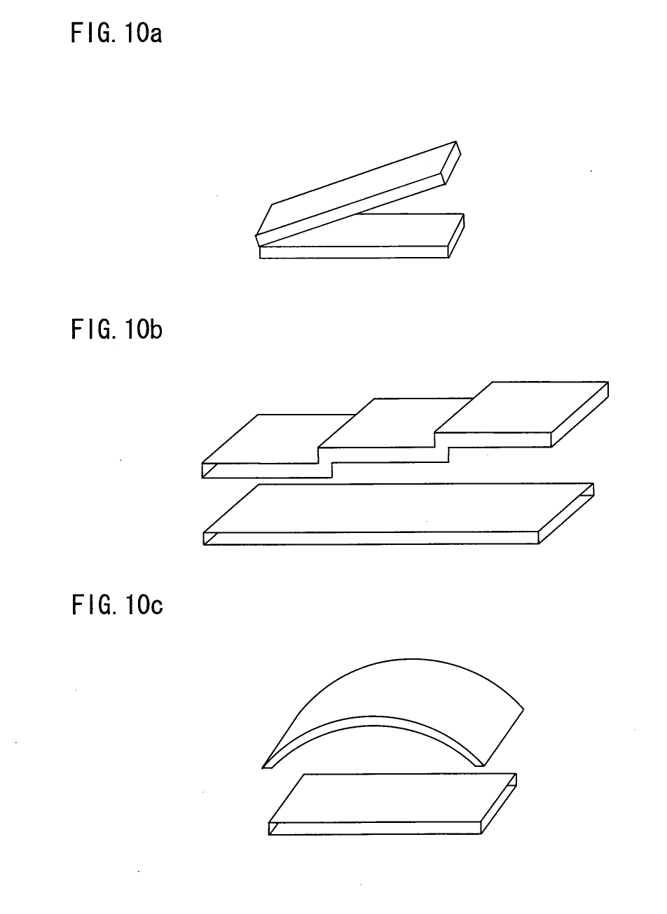

FIGS. 10a, 10b and 10c depict the examples of the types of substrates that may be used to define the liquid crystal cell of varying thickness. In the embodiment of FIG. 10a, the liquid crystal is of gradually increasing thickness and shaped like a wedge. FIG. 10b shows a planar lower solid substrate and a solid upper substrate with several discrete heights. The resulting liquid crystal will have a thickness that increases in a stepwise manner. In the liquid crystal in embodiment shown in FIG. 10c, the spatially varying thickness of liquid crystal may be provided by the first and second substrates forming a ‘curved’ surface to provide continuous changes in the thickness of the liquid crystal layer.

### Embodiment 11

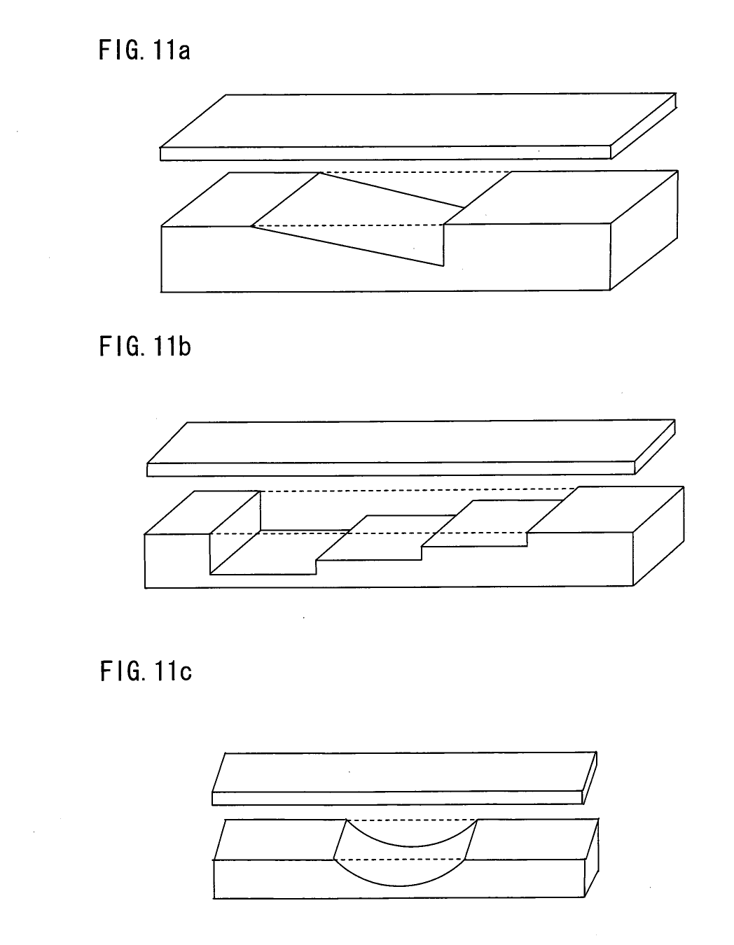

FIGS. 11a, 11b and 11c depict further examples of the types of substrate, that may be used to depict the liquid crystal cell.

### EXAMPLE 1

This example illustrates the ‘step’ format where three cells of different liquid crystal (cell) thickness are used to detect a molecular binding event. The effect of initial receptor concentration on the alignment of the liquid crystal and the thickness at which different receptor deposition concentrations switch the alignment of the liquid crystal are also demonstrated.

A proprietary synthetic peptide, P1, which spontaneously attaches to a surface, was synthesized (the first analyte in this example). A second proprietary synthetic peptide, P2, which covalently attaches to P1 was also synthesized (the second analyte in this example).

Liquid crystal 5CB (4-cyano-4′-pentylbiphenyl) was purchased from Kingston Chemicals, UK and liquid crystal, E7 was purchased from Merck, Germany. E7 consists of 3 cyanobiphenyls with pentyl, heptyl and octyloxy substituents and 1 cyanoterphenyl with a pentyl group. E7 is approximately 50% 5CB.

Indium tin oxide (ITO) coated glass was used as the substrate on which to bind the peptides. The ITO coated glass slides were cleaned by wiping the surface with isopropanol (IPA) using a cotton bud and then allowing the ITO surface to dry thoroughly on a hotplate at 70° C. for 10 minutes.

A series of four 2-fold dilutions of the 10 μM stock P1 was made in dimethylsulfoxide (DMSO) containing 1 μM tris-(carboxyethyl)phosphine (TCEP). This series of 2-fold dilutions was pipetted onto the clean ITO glass in 2 μl volumes in two rows. The P1 peptide samples were placed on a hotplate at 70° C. for 1 hour in order to dry. Once dry, the samples were washed vigorously in wash buffer consisting of 10 mM tris-HCl (pH 8.0) and 0.1% (v/v) Tween-20 for 30 seconds. The Tween-20 wash buffer was rinsed off using deionised water for 30 seconds and the sample was dried using an air gun.

P2 was then bound to the 2-fold dilution series of P1 on the bottom row of each sample. P2 was dissolved in 10 μM tris-HCl (pH 8.0) containing 0.1% (v/v) Tween-20, and is able to couple to arrayed P1. 2 μl volumes of 25 μM P2 was used to overlay each of the original P1 spots occupying the bottom row and was left to dry under ambient conditions. The top row of spots were overlaid with 2 μl of deionised water to rule out any effects caused by water. This is detailed in Table 1. Once dry, the sample was again washed in wash buffer for 30 seconds, rinsed using deionised water for 30 seconds and dried using an air gun.

TABLE 1
Layout of 2-fold dilution series of P1 over two rows
with the bottom row forming dimers using 25 μM P2

| | Concentration of P1 on ITO surface | | | |
|---|---|---|---|---|
| Unbound | 1.25 μM | 2.5 μM | 5 μM | 10 μM |
| P1 | | | | |
| Bound | 1.25 μM | 2.5 μM | 5 μM | 10 μM |
| P1/P2 | | | | |

Three sets of cells were then fabricated that were 5 μm, 20 μm and 50 μm thick using an IPA cleaned ITO substrate as the upper lid of the cell. The 5 μm thick cells were fabricated using spacer balls while the 20 μm and 50 μm thick cells were fabricated using aluminium foil and mylar respectively. The 5 μm thick cells were glued together using UV glue while the thicker samples were held together using bull dog clips.

These samples were capillary filled on an 80° C. hotplate with liquid crystal 5CB and viewed through crossed polarisers for analysis. This experiment was then repeated with a different liquid crystal, E7.

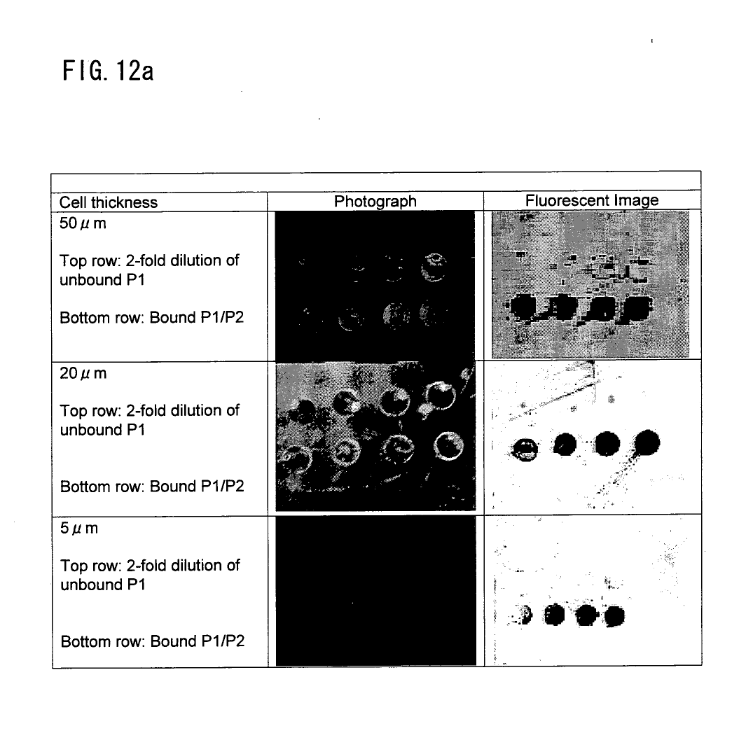

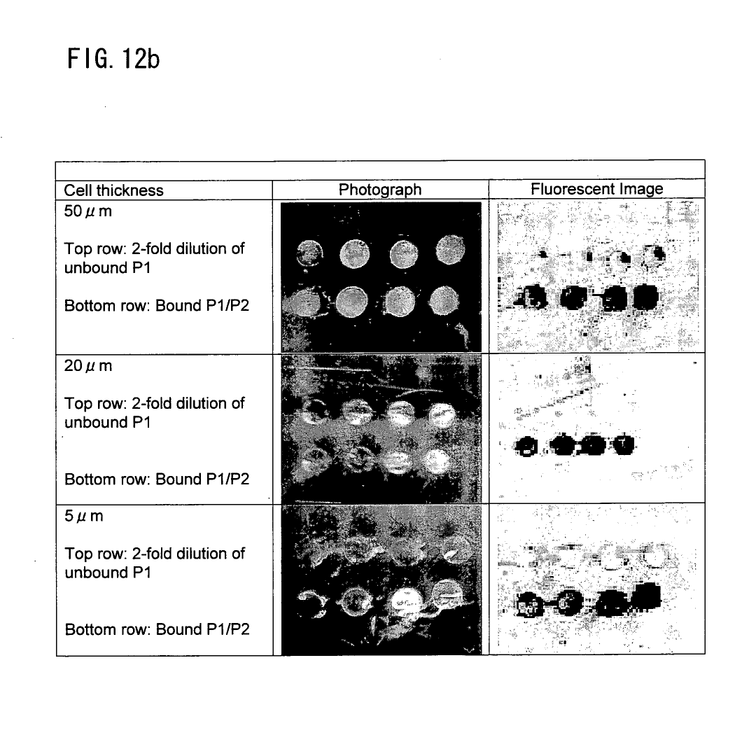

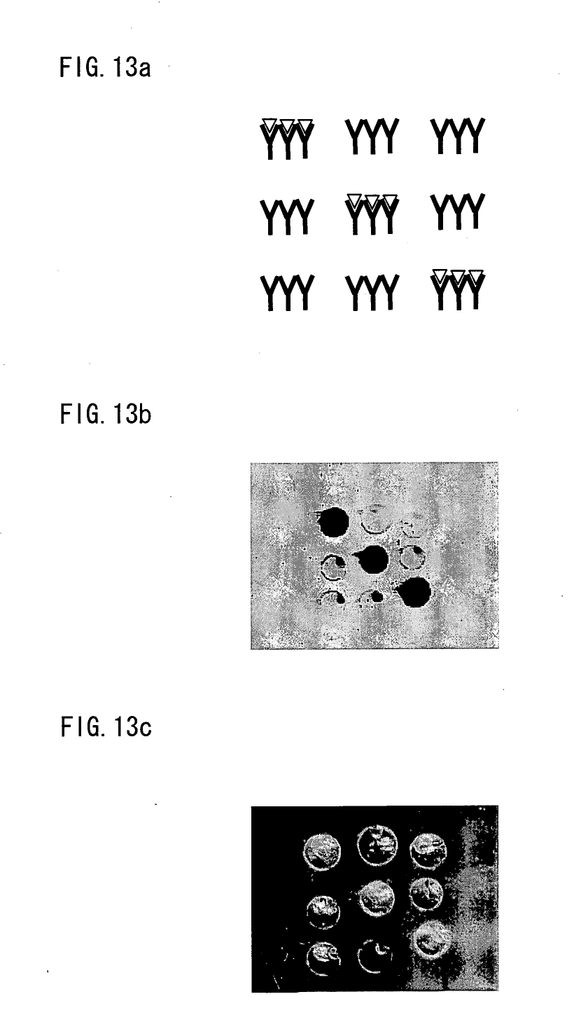

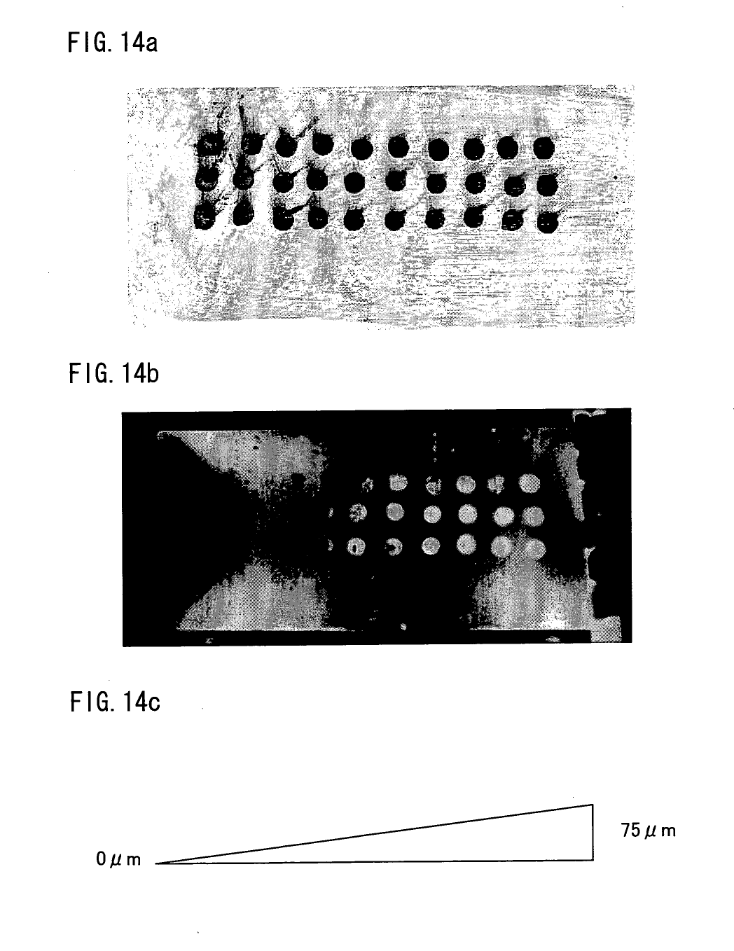

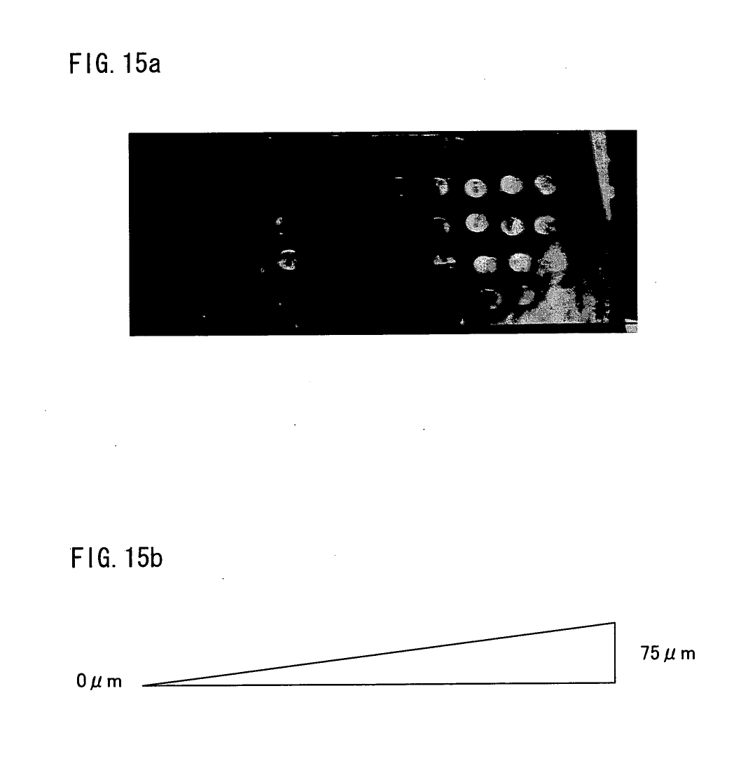

A summary of the induced alignment for different P1 concentrations on ITO in different cell thicknesses filled with 5CB is shown in FIG. 12a. This highlights a window within which it is possible to differentiate between unbound P1 and bound P1/P2. This system can be used to detect binding events when the deposited P1 peptide has a concentration between 2.5 μM and 5 μM, fabricated into a cell that is 50 μm thick and filled with 5CB. In this region, P1 spots appear homeotropic while P1/P2 dimers induce planar alignment of the liquid crystal and therefore appear bright when viewed through crossed polarisers. The P2 molecules in this instance are fluorescently labelled and therefore binding of P2 to P1 can be confirmed by imaging the fluorescence from the substrate.

Fluorescent scans were carried out on a Typhoon Trio Plus variable mode imager (Amersham Biosciences) with the green (532 nm) laser and the 580 BP 30 filter at the PMT voltages indicated below and at normal sensitivity. The scan height was set at platen and the sample was not pressed during scanning. The PMT voltage was 600V for each scan and the samples were imaged at 25 μm resolution.

This result highlights the fact that liquid crystals are highly sensitive and there is a window within which the binding of the P2 molecule is sufficient to change the surface properties enough to switch the alignment of the liquid crystal. On either side of this transition, all the peptide spots in the cell align in either a homeotropic or planar fashion. The alignment of the liquid crystal at different cell thicknesses and for different P1 deposition concentrations using liquid crystal 5CB are given in Table 2.

TABLE 2
Phase-diagram for LIQUID CRYSTAL cells filled
with 5CB Peptides on ITO substrate with ITO lid

| | Peptide 1 deposition concentration | | | |
|---|---|---|---|---|
| | 1.25 μM | 2.5 μM | 5 μM | 10 μM |
| | Unbound/ | Unbound/ | Unbound/ | Unbound/ |
| Cell thickness | Bound | Bound | Bound | Bound |
| 50 μm | ⊥ ⊥ | ⊥ \|\| | ⊥ \|\| | \|\| \|\| |
| 20 μm | ⊥ ⊥ | ⊥ ⊥ | ⊥ ⊥ | ⊥ ⊥ |
| 5 μm | ⊥ ⊥ | ⊥ ⊥ | ⊥ ⊥ | ⊥ ⊥ |

⊥ Homeotropic alignment; liquid crystal mesogen orients perpendicular to the substrate surface.
|| Planar alignment; liquid crystal mesogen orients parallel to the substrate surface.

As can be seen from Table 2, a cell thicker than 50 μm would be required to transduce (a) the bound P1/P2 entity and that an even thicker liquid crystal cell would be required to transduce (b) the unbound P1 entity where the P1 deposition concentration was 1.25 μM. At the other extreme where the P1 deposition concentration was 10 μM, a cell thickness between 20 μm and 50 μm would be required to differentiate between the unbound P1 and bound P1/P2 entities. For the cells where the P1 deposition concentration was 2.5 μM and 5 μM, a cell thicker than 50 μm will be required to confirm successful deposition of the P1 receptor.

A similar alignment properties table was made for liquid crystals filled with the liquid crystal E7. This is shown in Table 3. As can be seen, the alignment properties of Table 3 are very different to that described in Table 2. In this instance, a P1 binding event with P2 can only be differentiated from an unbound P1 spot using E7 when high concentrations, greater than 5 μM, of P1 are deposited on the ITO surface and the liquid crystal cell is very thin (5 μm). Compare this to the lower P1 concentrations (2.5 μM and 5 μM) required in a very thick (50 μm) cell filled with 5CB. This is particularly interesting considering that E7 is ˜50% 5CB. This shows that small changes in chemical composition of the liquid crystal used can have a profound affect on the conditions required to induce a change in liquid crystal alignment.

TABLE 3
Phase-diagram for liquid crystal cells filled
with E7 Peptides on ITO substrate with ITO lid

Peptide 1 deposition concentration

| | 1.25 μM | 2.5 μM | 5 μM | 10 μM |
|---|---|---|---|---|
| Cell | Unbound/ | Unbound/ | Unbound/ | Unbound/ |
| thickness | Bound | Bound | Bound | Bound |
| 50 μm | \|\| \|\| | \|\| \|\| | \|\| \|\| | \|\| \|\| |
| 20 μm | ⊥ ⊥ | ⊥ ⊥ | \|\| \|\| | \|\| \|\| |
| 5 μm | ⊥ ⊥ | ⊥ ⊥ | ⊥ \|\| | ⊥ \|\| |

⊥ Homeotropic alignment; liquid crystal mesogen orients perpendicular to the substrate surface.
|| Planar alignment; liquid crystal mesogen orients parallel to the substrate surface.

The results of Table 3 can be visualised in FIG. 12b where photographs and fluorescent images of the cells fabricated are given.

With reference to Table 3, it can be seen that in order to differentiate between an unbound P1 and a bound P1/P2 when the initial P1 deposition concentration was 1.25 μM and 2.5 μM that a cell thickness between 20 μm and 50 μm is required. For higher P1 deposition concentrations, namely 5 μM and 10 μM, then differentiation between unbound P1 and bound P1/P2 occurs in a 5 μm thick cell. It is interesting to note that at the highest P1 deposition concentration and in the 5 μm thick cell, that the birefringent properties of the liquid crystal cause the spot to appear red through crossed polarisers. Optimising this could enable different stages of the transduction process to appear as different coloured spots to aid interpretation.

For each concentration of receptor deposition, and choice of preferred liquid crystal, there is a range of liquid crystal cell thicknesses that can be utilised to confirm (a) successful deposition of the receptor, (b) and interaction with an analyte and (c) quality control.

### EXAMPLE 2

Illustrates a 3×3 array of P1 receptors where dimers with P2 have been formed along the top left to bottom right diagonal. The P1 and P2 solutions were prepared in the same way as described in Example 1. A 3×3 array of 2 μl volumes of 5 μM stock P1 receptors in DMSO were deposited onto an IPA-cleaned ITO glass substrate. The P1 peptide samples were placed on a hotplate at 70° C. for 1 hour in order to dry. Once dry, the samples were washed vigorously in wash buffer consisting of 10 mM tris-HCl (pH 8.0) and 0.1% (v/v) Tween-20 for 30 seconds. The Tween-20 wash buffer was rinsed off using deionised water for 30 seconds and the sample was dried using an air gun.

2 μl volumes of 25 μM P2 was used to overlay three of the original P1 spots on the diagonal from top left to bottom right, see FIG. (13a), and were left to dry under ambient conditions. The remaining P1 spots were overlaid with 2 ml of deionised water to rule out any effects caused by water. Once dry, the sample was again washed in wash buffer for 30 seconds, rinsed using deionised water for 30 seconds and dried using an air gun.

A 50 μM thick liquid crystal cell was fabricated using Mylar spacers and was held together with bulldog clips. The liquid crystal cell was heated to 80° C. and filled with 5CB.

The fluorescent image confirms that P1/P2 dimers were formed on the diagonal, see FIG. (13b), and the image of the cell through crossed polarisers, FIG. (13c), shows the liquid crystal switching from homeotropic to homeoplanar orientation detecting the P1/P2 interaction.

### EXAMPLE 3

A proprietary synthetic peptide, P3, which spontaneously attaches to a surface, was synthesized (the first analyte in this example).

ITO coated glass slides were cleaned by wiping the surface with some IPA using a cotton bud and allowing to dry under ambient conditions.

10 μl of 10 μM P3 in water (which is labelled with TAMRA) was pipetted onto the cleaned ITO glass in a 10×3 array and left for 10 minutes. Then the excess material was pipetted off, the sample was then rinsed under DI water and dried using an air gun. A row of 10 μl of DI water was pipetted onto the substrate below the P3 peptide rows.

Each sample was imaged at 50 μm resolution on a Typhoon Trio Plus variable mode imager (Amersham Biosciences) with the green (532 nm) laser and the 580 BP 30 filter at the PMT voltages indicated below and at normal sensitivity. The scan height was set at platen and the sample was pressed during scanning. The PMT voltage was 600V for each scan. A silicon wafer was used to help suppress spurious background fluorescence.

A wedge cell was made using 75 μm thick mylar at one end and filled with liquid crystal E7 on a hotplate.

FIG. (14a) shows the fluorescent scan of the ITO substrate. FIG. (14b) is a photograph taken through crossed polarisers of the substrate fabricated into a 0-75 μm thick wedge cell filled with E7. FIG. (14b) clearly shows that the liquid crystal begins switching orientation under the presence of the P3 peptide as the cell thickness increases. The DI water control row has no impact on liquid crystal orientation. FIG. (14c) is a schematic of the wedge cell to illustrate how the thickness of the cell changes.

### EXAMPLE 4

A proprietary synthetic peptide, P4, which spontaneously attaches to a surface, was synthesized (the first analyte in this example).

ITO coated glass slides were cleaned by wiping the surface with some IPA using a cotton bud and allowing to dry under ambient conditions.

10 μl of 10 μM P4 in water (which is labelled with TAMRA) was pipetted onto the cleaned ITO glass in a 10×3 array and left for 10 minutes. Then the excess material was pipetted off, the sample was then rinsed under DI water and dried using an air gun. A row of 10 μl of DI water was pipetted onto the substrate below the P4 peptide rows.

A wedge cell was made using 75 μm thick mylar at one end and filled with liquid crystal E7 on a hotplate.

FIG. (15a) is a photograph taken through crossed polarisers of the resulting P4 peptide wedge cell. Firstly, the liquid crystal E7 switches orientation as the thickness of the wedge cell increases. This peptide does not bind to the ITO surface as well as P3 and as a result formed an aggregate at three locations where the cell is thin. At these locations, the liquid crystal has switched orientation thus illustrating the ability of a wedge cell to contain built-in quality control. In short, this cell should be disposed of and the experiment repeated. FIG. (15b) illustrates how the wedge cell increases in thickness.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

As described above, the present invention provides a device for detecting an analyte. Because this device makes use of a liquid crystal cell with varying spatial thickness, molecular interactions with a variable threshold (due to different strengths of interactions) may be detected in a single operation. The present invention can also be used to obtain quantitative information on the strength of molecular binding interactions and to confirm the correct operation of the device.

1. A device for detecting interactions between a surface and an analyte, said device comprising
a first substrate having an active surface supporting one or more first analyte(s),
a second substrate, and
a liquid crystal disposed on the active surface between the first substrate and second substrate, wherein the liquid crystal has a cross-section of varying thickness, wherein the cross-section of the liquid crystal has a first thickness and second thickness that is different to the first thickness, whereby the interaction between the active surface and the first analyte causes the orientation of the liquid crystal to change at a first critical thickness that is between the first and second thicknesses of the liquid crystal, wherein interaction between the first analyte and the further analyte causes the orientation of the liquid crystal to change at a further critical thickness that is different to the first critical thickness and between the first and second thickness of the liquid crystal.

2. A device as claimed in claim 1, wherein the first thickness is different to the second thickness by an amount ranging from 0.1 nm to 5 mm.

3. A device as claimed in claim 1, wherein the first analyte is supported on the surface in discrete regions.

4. A device as claimed in claim 3, wherein the surface supports an array of different first analytes.

5. A device as claimed in claim 4, wherein an array of different second analytes are bound to the array of different first analytes.

6. A device as claimed in claim 1, wherein the first analyte and/or any further analyte is a protein, peptide, metabolite, nucleic acid, drug, allergen, antibody and/or antigen.

7. A device as claimed in claim 1, wherein the liquid crystal has a cross-section having a gradually increasing thickness.

8. A device as claimed in claim 1, wherein the liquid crystal has a cross-section that increases in thickness in a stepwise manner.

9. A device as claimed in claim 1, wherein the first substrate and/or second substrate are substantially transparent.

10. A device as claimed in claim 9, wherein the first substrate and/or the second substrate are glass substrates coated with indium tin oxide.

11. A device as claimed in claim 1, wherein, in the absence of any analyte, the first substrate and second substrate provide homeotropic anchoring for liquid crystal mesogens.

12. A device as claimed in claim 1, wherein, in the absence of any analyte, the first substrate and second substrate provide planar anchoring for liquid crystal mesogens.

13. A device as claimed in claim 1, wherein the liquid crystal comprises 5CB (4-cyano-4′-pentylbiphenyl).

14. A method of detecting an interaction between a surface and an analyte, said method comprising
providing a first solid substrate having an active surface for supporting at least one analyte,
depositing a first analyte on the active surface,
providing a second substrate,
forming a liquid crystal on the active surface between the first substrate and second substrate, wherein the liquid crystal has a cross section of varying thickness, and
detecting the orientation of the liquid crystal.

15. A method as claimed in claim 14, which comprises detecting the orientation of the liquid crystal at different liquid crystal thicknesses to determine the critical thickness at which the interaction between the first analyte and the active surface causes a change in liquid crystal orientation.

16. A method as claimed in claim 14, wherein at least one further analyte is contacted with the first analyte prior to formation of the liquid crystal.

17. A method as claimed in claim 14, wherein at least one further analyte is contacted with the liquid crystal after the formation of the liquid crystal on the active surface.

18. A method as claimed in claim 16, which comprises detecting the orientation of the liquid crystal at different liquid crystal thicknesses to determine the critical thickness at which the interaction between the at least one further analyte and the first analyte causes a change in liquid crystal orientation.

19. A method as claimed in claim 14, wherein the first analyte is deposited on discrete regions of the active surface.

20. A method as claimed in claim 1, wherein the first analyte is deposited in a continuous manner on the active surface.

21. An apparatus for detecting an interaction between a surface and an analyte, said apparatus comprising
means for receiving a first substrate having an active surface for supporting at least one analyte,
a second substrate, and
means for forming a liquid crystal of varying thickness between a first substrate positioned in the apparatus and the second substrate.

22. An apparatus for detecting an interaction between a surface and an analyte, said apparatus comprising
means for receiving a first substrate having an active surface for supporting at least one analyte and a liquid crystal layer of varying thickness,
means of contacting the liquid crystal with a sample to be analyzed,
a second substrate, and
means of contacting the second substrate with the liquid crystal once it has been contacted with the sample.
